(19) United States
(12) Patent Application Publication
(10) Pub. No.: US 2015/0160111 A1
(43) Pub. Date: Jun. 11, 2015

(54) VISCOMETER

(71) Applicant: VIDEOJET TECHNOLOGIES INC., Wood Dale, IL (US)

(72) Inventors: Emma Lewis, Cambridge (GB); Simon Jordan, Upper Cambourne (GB); Michael Stamp, LEICESTER (GB); Simon Mark Lawson, LEICESTER (GB)

(73) Assignee: VIDEOJET TECHNOLOGIES INC., Wood Dale, IL (US)

(21) Appl. No.: 14/098,907

(22) Filed: Dec. 6, 2013

(51) Int. Cl. G01N 11/16

(52) U.S. Cl. CPC G01N 11/162

(57) ABSTRACT

A viscometer includes a housing and a bob disposed in the housing such that a gap is provided between the bob and the housing. The bob includes a magnet. A linear support supports the bob such that the bob is free to rotate with respect the housing. A flow inlet in the housing provides fluid flow into the housing. A flow outlet provides fluid flow out of the housing. At least one coil is disposed adjacent the housing for providing a magnetic field to induce oscillating rotational movement in the bob and to measure the movement of the bob. The viscometer is configured to measure a viscosity of a fluid by inducing movement in the bob and measuring a dampening effect of the fluid.

### BACKGROUND

The present disclosure relates to a viscometer for measuring the viscosity of a fluid. It is particularly useful for measuring the viscosity of ink in an ink jet printer.

In ink jet printing systems the print is made up of individual droplets of ink generated at a nozzle and propelled towards a substrate. There are two principal systems: drop on demand where ink droplets for printing are generated as and when required; and continuous ink jet printing in which droplets are continuously produced and only selected ones are directed towards the substrate, the others being recirculated to an ink supply.

Continuous ink jet printers supply pressurized ink to a print head assembly having a drop generator where a continuous stream of ink emanating from a nozzle is broken up into individual regular drops by an oscillating piezoelectric element. The drops are directed past a charge electrode where they are selectively and separately given a predetermined charge before passing through a transverse electric field provided across a pair of deflection plates. Each charged drop is deflected by the field by an amount that is dependent on its charge magnitude before impinging on the substrate whereas the uncharged drops proceed without deflection and are collected at a gutter from where they are recirculated to the ink supply for reuse. A phase measurement system is also usually present as part of deflection plate assembly and is used to ensure synchronization of deflection for the droplets. The charged drops bypass the gutter and hit the substrate at a position determined by the charge on the drop and the position of the substrate relative to the print head assembly. Typically the substrate is moved relative to the print head assembly in one direction and the drops are deflected in a direction generally perpendicular thereto, although the deflection plates may be oriented at an inclination to the perpendicular to compensate for the speed of the substrate (the movement of the substrate relative to the print head assembly between drops arriving means that a line of drops would otherwise not quite extend perpendicularly to the direction of movement of the substrate).

In continuous ink jet printing a character is printed from a matrix comprising a regular array of potential drop positions. Each matrix comprises a plurality of columns (strokes), each being defined by a line comprising a plurality of potential drop positions (e.g. seven) determined by the charge applied to the drops. Thus each usable drop is charged according to its intended position in the stroke. If a particular drop is not to be used then the drop is not charged and it is captured at the gutter for recirculation. This cycle repeats for all strokes in a matrix and then starts again for the next character matrix.

Ink is delivered under pressure to the print head assembly from an ink supply system that is generally housed within a sealed compartment of a cabinet that includes a separate compartment for control circuitry and a user interface panel. The system includes a main pump that draws the ink from a reservoir or tank via a filter and delivers it under pressure to the print head assembly. As ink is consumed the reservoir is refilled as necessary from an ink source such as a replaceable ink cartridge that is releasably connected to the reservoir by a supply conduit. The ink is fed from the reservoir via a flexible delivery conduit to the print head assembly. Electrical power to operate the heater in the print head assembly and the drop generator are supplied by power supply system cables, typically forming part of the supply conduit. The unused ink drops captured by the gutter are recirculated to the reservoir via a return conduit, typically located as part of the supply conduit, by a pump. The flow of ink in each of the conduits is generally controlled by solenoid valves and/or other like components.

As the ink circulates through the system, there is a tendency for it to thicken as a result of solvent evaporation. To maintain proper operation of the printer, the ink needs to be maintained at a certain solids content. Solvent is lost through evaporation; over time, this leads to an increase in the viscosity of the ink which will lead to a loss of print quality and possible blocking of the head. The viscosity is corrected by adding make-up solvent to the ink tank. For optimum jetting behavior the viscosity of the ink needs to be known or controlled to better than 0.5 cP. Thus, by measuring the viscosity of the printing fluid, proper operation of the printer may be maintained.

A prior method to calculate the viscosity in an ink jet printer uses measurements of the back pressure in the jetting nozzle and the droplet speed in the printhead. However, this measurement needs to be calibrated for each different ink. This requires a site visit by an engineer who calibrates the ink viscosity using a time-to-empty system. This step introduces additional downtime, costs and potential for error. In addition, the low flow rate in the nozzle feed means that the response to changes in the viscosity of the ink in the tank is slow. Prior viscometers for ink jet printers tend to be bulky, inaccurate, or expensive.

### BRIEF SUMMARY

The present disclosure provides a viscometer for measuring the viscosity of a fluid. The viscometer is especially useful for measuring the viscosity of a fluid used in an ink jet printer. The viscometer uses a bob that is suspended or supported in the fluid. By inducing oscillating rotational movement of the bob, the decay of the movement provides a measurement of the viscosity of the fluid.

In one aspect, a viscometer includes a housing and a bob disposed in the housing such that a gap is provided between the bob and the housing. The bob includes a magnet. A linear support supports the bob such that the bob is free to rotate with respect the housing. A flow inlet in the housing provides fluid flow into the housing. A flow outlet provides fluid flow out of the housing. At least one coil is disposed adjacent the housing for providing a magnetic field to induce oscillating rotational movement in the bob and to measure the movement of the bob. The viscometer is configured to measure a viscosity of a fluid by inducing movement in the bob and measuring a dampening effect of the fluid.

In another aspect, a method of measuring the viscosity of a fluid includes providing a viscometer with a housing, a bob disposed in housing such that a gap is provided between the bob and the housing, the bob including a magnet, and a linear support supporting the bob such that the bob is free to rotate with respect the housing. A fluid is disposed in the gap between the housing and the bob. A magnetic field is provided to induce oscillating rotational movement of the bob with respect to the housing. The oscillating rotational movement of the bob is measured and a viscosity of the fluid is determined from the decrease in oscillation amplitude of the bob with time.

The foregoing paragraphs have been provided by way of general introduction, and are not intended to limit the scope of the following claims. The presently preferred embodiments, together with further advantages, will be best understood by reference to the following detailed description taken in conjunction with the accompanying drawings.

### BRIEF DESCRIPTION OF THE DRAWINGS

FIG. 1 is a schematic view of an embodiment of a viscometer.

FIG. 2 is a perspective view of an embodiment of a viscometer.

FIG. 3 is a side view of the viscometer of FIG. 2.

FIG. 4 is a cross-sectional view along line 4-4 of FIG. 3.

FIG. 5 is a schematic view of an embodiment of a viscometer in an ink tank of an ink jet printer.

FIG. 6 is a graph showing the angular position as a function of time for a representative fluid.

FIG. 7 is a graph showing the angular amplitude as a function of time for the data of FIG. 6.

FIG. 8 is a graph showing the natural log of the angular position as a function of time for the data of FIG. 6.

### DETAILED DESCRIPTION

The invention is described with reference to the drawings in which like elements are referred to by like numerals. The relationship and functioning of the various elements of this invention are better understood by the following detailed description. However, the embodiments of this invention as described below are by way of example only, and the invention is not limited to the embodiments illustrated in the drawings.

The present disclosure provides a viscometer for measuring the viscosity of a fluid. The viscometer is especially useful for measuring the viscosity of a fluid used in an ink jet printer. The viscometer uses a bob that is suspended or supported in the fluid. By inducing oscillating rotational movement of the bob, the decay of the movement provides a measurement of the viscosity of the fluid. The viscometer is able to quickly calculate the viscosity with the desired accuracy and does not require any on-site or fluid-specific calibration or repair. The viscometer does not require any bearings to facilitate movement of the moving parts, and has minimal friction or wear between components. Additionally, the viscosity measurements are reproducible and do not change substantially with time.

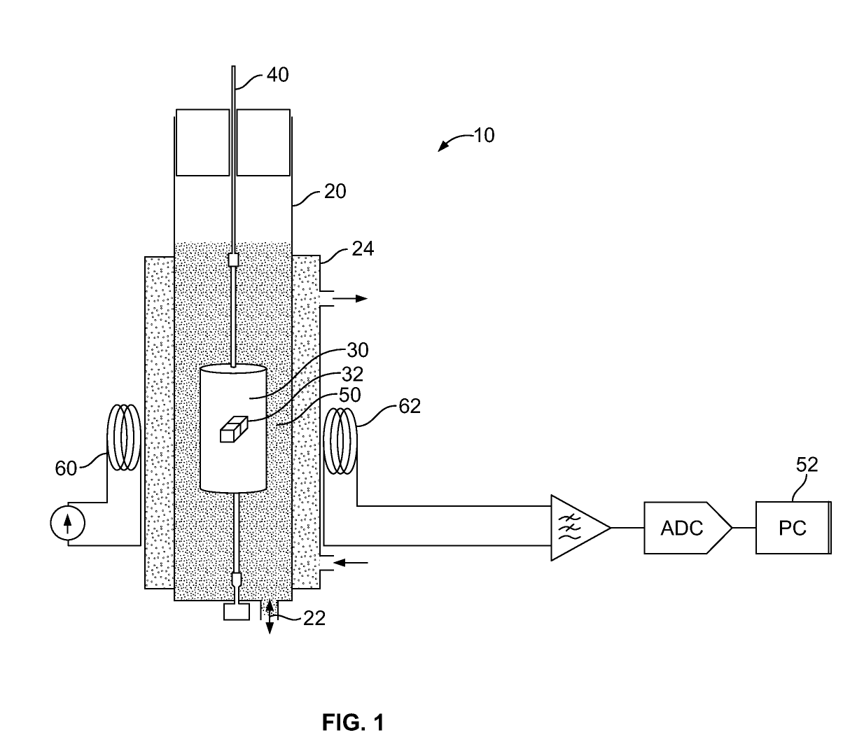

FIG. 1 shows a schematic of an embodiment of the viscometer 10. The viscometer includes a housing 20 and a bob 30 disposed in the housing 20. The bob 30 is supported by a linear support 40, such as a wire or torsion band, but is free to rotate around a support axis under the application of a torque. Preferably, the linear support 40 serves multiple functions, including acting as a spring, supporting the bob 30, and eliminating the need for any bearings or the like between moving parts in the viscometer. A gap 50 is provided between the bob 30 and the housing. The bob 30 includes a magnet 32 within it, so that the bob 30 can move in response to a magnetic field. The linear support 40 supports the bob 30 such that the bob 30 is free to rotate with respect the housing.

The housing 20 is designed to hold a fluid in the gap between the bob 30 and the housing. The housing 20 includes a flow inlet in the housing 20 for providing fluid flow into the housing 20 and flow outlet for providing fluid flow out of the housing. In the embodiment shown in FIG. 1, the inlet and outlet are both provided in port 22, but in other embodiments the inlet and outlet could be provided by separate ports. The embodiment in FIG. 1 also includes a water jacket 24 to control the temperature of the fluid.

At least one coil is disposed adjacent the housing 20 for providing a magnetic field to induce oscillating rotational movement in the bob 30 and to measure the movement of the bob. In the embodiment shown in FIG. 1, a first coil 60 induces oscillating rotational movement in the bob 30 and a second coil 62 measures the movement of the bob. In an alternative embodiment, the same coil induces oscillating rotational movement in the bob 30 and measures the movement of the bob 30.

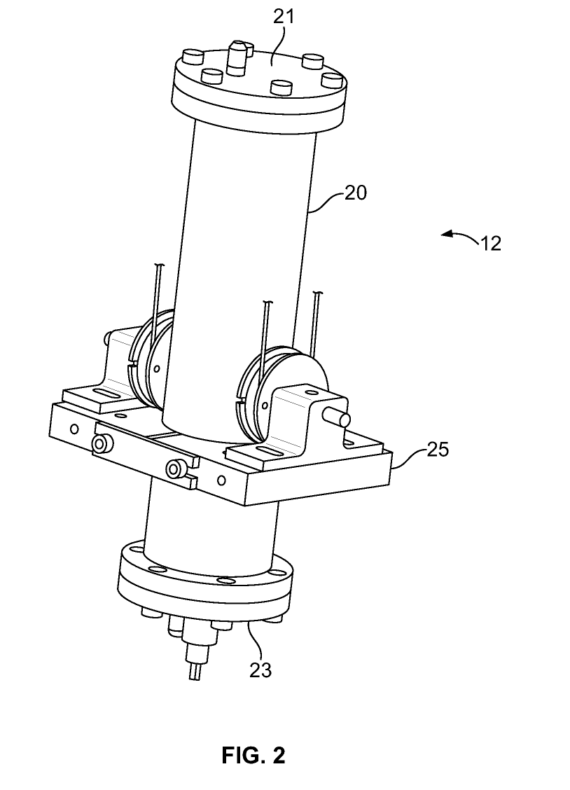

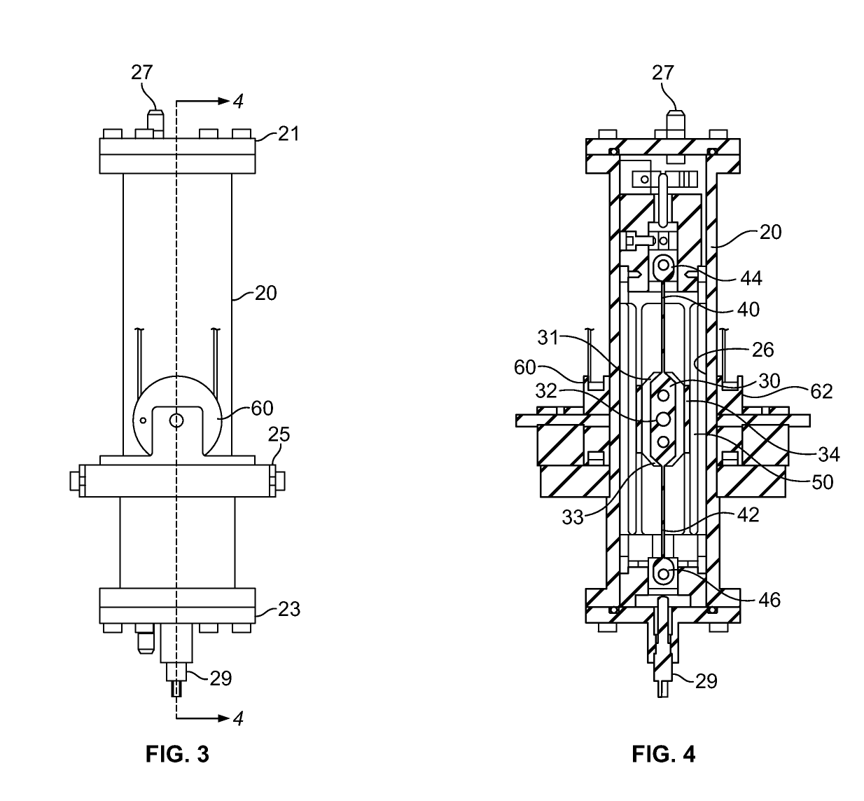

FIG. 2 is a perspective view of an embodiment 12 of a viscometer. The viscometer 12 includes a cylindrical housing 20, top 21, bottom 23, and flange 25 disposed below a midpoint of the cylinder. The flange 25 supports one or more coils 60, 62. In one embodiment, the first coil 60 induces oscillating rotational movement in the bob 30 and the second coil 62 measures the movement of the bob 30. FIG. 3 is a side view of the viscometer of FIG. 2. Fluid may be provided into the housing 20 by fluid inlet 27, and fluid may be removed from the housing by fluid outlet 29. It will be apparent that the fluid inlet and outlet may be transposed, or even disposed in different locations, depending on the desired use. The coil or coils 60, 62 should be aligned such that the axis of the coil 60, 62 is perpendicular to the axis of the magnet 32.

FIG. 4 is a cross-sectional view along line 4-4 of FIG. 3. The housing 20 can be of any suitable shape. In one embodiment, the housing 20 includes an inner surface 26 in the general shape of a hollow cylinder, the bob 30 includes an outer surface 34 in the general shape of a cylinder, and the gap 50 between the housing and the bob 30 is ring-shaped. However, the gap 50 does not need to be ring-shaped and can be any suitable shape; the gap generally will need to be at least a minimum distance. The bob 30 comprises tapered ends 31, 33 adjacent a connection with the linear support 40. The tapered ends 31, 33 help to minimize the accumulation of dried ink and the like on the surface of the bob 30.

The bob 30 may be supported by one or more linear supports 40, 42. The linear support 40, 42 may be a torsion band. The viscometer may include a first linear support 40 connecting a top of the bob 30 to a top portion of the housing 20 and a second linear support 42 connecting a bottom of the bob 30 to a bottom portion of the housing. In one embodiment, the top linear support 40 includes an end 44 that is anchored to a structure within the housing 20, and similarly the bottom linear support 42 includes an end 46 that is anchored to a structure within the housing 20. The linear supports 40, 42 are preferably under a predetermined tension to compensate for tilt and to obtain the correct torsion constant in the linear support. If the linear support is a torsion band, it may have a width of about 0.5 mm to 3 mm, preferably 1 mm to 1.5 mm and a thickness of about 25 micron to 200 micron, preferably 50 micron to 100 micron.

In typical configurations, the bob 30 is between 10 mm and 50 mm in length, 10 mm to 20 mm in diameter, and the gap between the bob 30 and the housing 20 is at least 4 mm. The components of the viscometer may be made of any suitable material, preferably materials that are resistant to organic solvents, such as stainless steel.

The viscometer is configured to measure a viscosity of a fluid by inducing oscillating rotational movement in the bob 30 and measuring a dampening effect of the fluid. The viscometer is capable of measuring the viscosity of a fluid between 0.1 and 20 cP. The viscometer is capable of measuring the viscosity of a fluid within 30 seconds or less.

A controller 52 is preferably in electrical communication with the coil or coils to initiate the movement of the bob and process the measurement data from the coil. The controller may be any suitable controller, such as a PC.

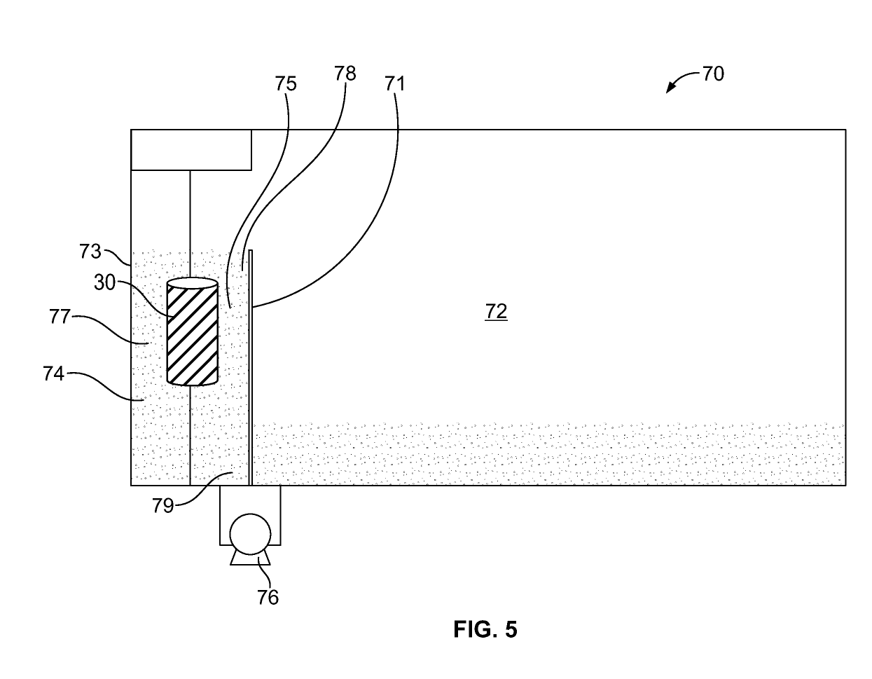

FIG. 5 shows an embodiment of a viscometer in the fluid tank 70 of an ink jet printer. The tank 70 includes a main tank 72 and a subtank 74. The bob 30 of viscometer is disposed in the subtank 74. Wall 71 of the subtank 74 and wall 73 of the tank 70 act as the housing, with gaps 75, 77 provided between the bob 30 and the respective walls 71, 73. The ink may be transported from the main tank 72 to the subtank 74 by any suitable method. In one arrangement, ink is provided by a pump 76 from the main ink tank 72 to the subtank 74. The pump 76 may deliver the ink from the main tank 72 to any suitable part of the subtank 74, such as the top 78 of the subtank 74, the bottom 79 of the subtank 74, or in between the top 78 and the bottom 79. The outlet of the subtank 74 may be provided at any suitable location of the subtank 74. In one embodiment, the outlet is provided by allowing the ink to overflow over the top 78 of wall 71 of the subtank 74 into the main tank 72. It will be apparent that other arrangements are possible.

In use, the viscometer operates as follows. A fluid is disposed in the gap 50 between the housing 20 and the bob 30. A magnetic field is generated by the coil 60 to induce oscillating rotational movement of the bob 30 with respect to the housing 20. The angular position or displacement of the bob 30 is then measured. The fluid dampens the amplitude of the movement of the bob 30 with time. The oscillating rotational movement of the bob 30 is measured by the coil 62. In the present viscometer the bob 30 oscillates and the angular displacement is over at least several degrees (such as at least 10°, 20°, 30°, or 45°). As will be discussed in the Examples below, the viscosity can be determined by measuring the decrease in the angular amplitude with time, or equivalently by measuring changes in a width of a resonance peak in a frequency spectrum. A damping constant of the system is calculated, from which the fluid viscosity can be calculated.

The appropriate specifics of measurement and data acquisition can be determined by the desired application. In a preferred embodiment, the movement of the bob 30 is measured at a rate that is at least twice the oscillation frequency; in one embodiment, the rate of measurement is at least 20 times a second. The system may also include a thermocouple or other temperature measurement mechanism to determine the temperature of the fluid, since it is well known that viscosity of a fluid is a function of temperature. The system is preferably capable of determining a viscosity of the fluid to within 0.01 cP at a temperature of 0° C. to 60° C., preferably 20° C. to 40° C. The system is capable of determining a viscosity of fluids with densities in the range of 0.5 to 1.2 g/cm³, preferably 0.7 to 0.9 g/cm³

The viscometer can be used to measure the viscosity of any suitable fluid. The viscometer is especially suitable for measuring the viscosity of organic solvent-based inks. Inks typically include a dye and an organic solvent selected from methyl ethyl ketone, acetone, ethanol, and mixtures thereof. The fluid may also include a binder resin and other additives such as surfactants, plasticizers, co-solvents, humectants, pigments, and the like. When used with an ink jet printer, the viscometer is in fluid communication with, or located within, a fluid tank of the printer. The fluid within the viscometer is refreshed at desired intervals to measure the viscosity of the current fluid within the printer. The viscosity may be measured with still (non-moving) fluid, or with fluid moving past the bob in the viscometer. The fluid may be refreshed at regular intervals (for examples, every 1, 5, 15, or 60 minutes). Additionally or alternatively, the viscosity may be measured during certain periods of operation of the printer (such as at startup, or during cleaning processes).

In general terms, the viscometer works by measuring the decay of oscillations of a cylindrical bob 30 suspended on a linear support such as a torsion band, and calculating the viscosity using the following equation:

$$viscosity = \frac{{( K \times ( decay constant ) + C )}^{2}}{frequency \times density}$$

The decay constant can be measured in two different ways: directly from the change in amplitude over time, or from the width of the resonance peak in the frequency spectrum. For “ideal” data where the pickup coil voltage V=Aexp(−γt)cos(ωt), the two methods of calculating the decay constant give exactly the same answer. In practice, for real data, V is not given exactly by the equation above and the two methods may produce slightly different answers. In a preferred embodiment, the controller uses software to calculate the decay constant using both methods and outputs both values.

The viscometer needs to be calibrated using two or more test fluids. The calibration is used to determine the constants K and C. The viscometer measures the frequency and decay constant, and then calculates the viscosity using the known values of K, C and the density, and the measured values of the frequency and decay constant.

### Example

The motion of the bob of the viscometer of FIGS. 2-4 follows the equations:

$$\begin{matrix}θ ( t ) = {θ}_{0} {e}^{- γ t} cos ( {ω}_{0} t ) & ( 1 ) \\ γ = A \cdot \sqrt{{ω}_{0} ηρ} & ( 2 ) \\ A = \frac{π {r}^{3} L}{\sqrt{2} M} & ( 3 )\end{matrix}$$

where

θ=angular displacement of bob

γ=damping constant

ω₀=2πf₀=oscillation frequency

η=viscosity

ρ=fluid density

r=bob radius

L=bob length

M=bob moment of inertia

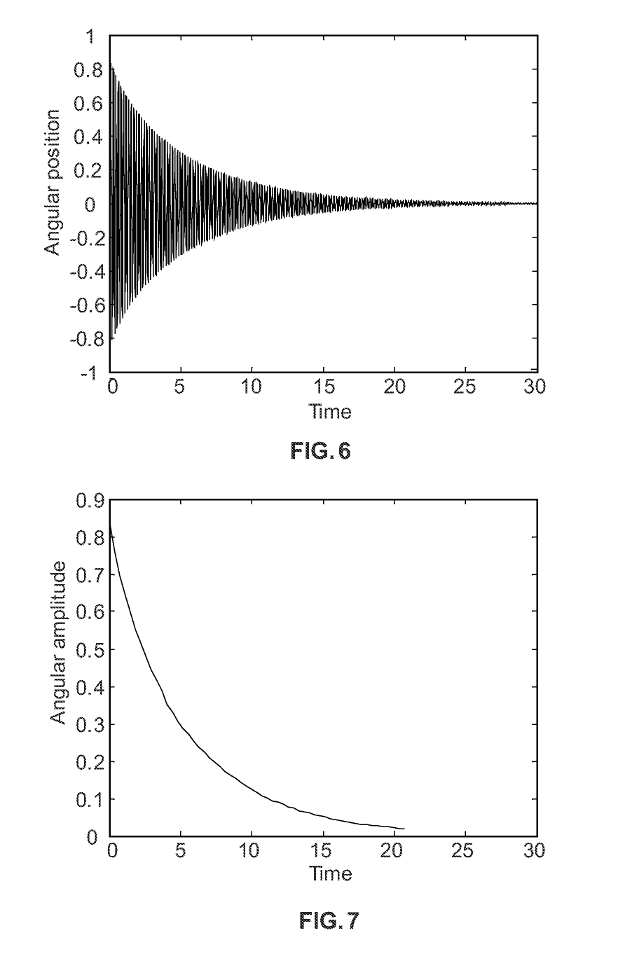

The system measures the angular position of the bob as a function of time, as shown in FIG. 5. The angular amplitude can be determined from this data, as shown in FIG. 6. The viscosity of a fluid can determined by fitting angular displacement data to an equation of the form

\sqrt{ηf₀ρ}=Kγ+C (4)

where K and C are constants determined by calibrating the system.

To measure the viscosity we need to know the value of ρ, and determine the values of f₀ (or ω₀) and γ by measuring the motion of the bob. Two different methods can be used determine γ as described below. In this example, the fluid used was water.

In a first Method, γ is calculated from the amplitude of the oscillation. The amplitude of the oscillation is given by θ₀e^{-γt}. The value of γ can be extracted by calculating

ln(θ₀e^{-γt})=ln(θ₀)−γt

As shown in FIG. 7, plotting this quantity against time gives a straight line with slope −γ.

In a second Method, γ can be calculated from the frequency spectrum of the oscillation. The frequency spectrum needs to be calculated for both methods to find the oscillation frequency f₀ (because f₀ is needed in order to calculate the viscosity using Equation 4). The frequency spectrum is calculated using a Fourier transform.

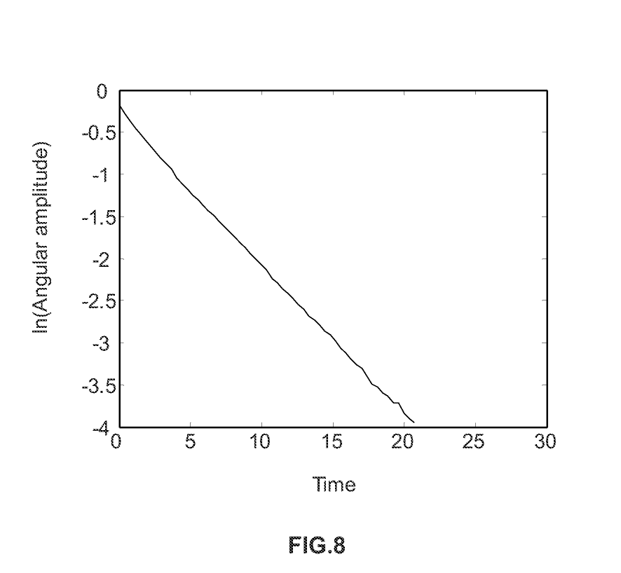

Various forms of the Fourier transform can be used to perform the calculation of γ. One way is to use the power spectrum (the squared amplitude of the Fourier transform). An example of the power spectrum versus frequency is shown in FIG. 8. The peak in the power spectrum has the form

$$P ( f ) = \begin{matrix}1 \\ {γ}^{2} + 4 {{π}^{2} ( f - {f}_{0} )}^{2}\end{matrix}$$

In other words, the power spectrum has a peak centered on f₀, with width determined by the value of γ.

The decay constant γ can be determined by measuring width of the peak. The height of the peak drops to half of its maximum value when γ=2π|f−f₀|, so the full width at half maximum of the peak is given by

$$Δ {f}_{FWHM} = \frac{γ}{π} .$$

The viscometer measures the frequency and decay constant, and then calculates the viscosity using the known values of K, C and the density, and the measured values of the frequency and decay constant.

The described and illustrated embodiments are to be considered as illustrative and not restrictive in character, it being understood that only the preferred embodiments have been shown and described and that all changes and modifications that come within the scope of the inventions as defined in the claims are desired to be protected. It should be understood that while the use of words such as “preferable”, “preferably”, “preferred” or “more preferred” in the description suggest that a feature so described may be desirable, it may nevertheless not be necessary and embodiments lacking such a feature may be contemplated as within the scope of the invention as defined in the appended claims. In relation to the claims, it is intended that when words such as “a,” “an,” “at least one,” or “at least one portion” are used to preface a feature there is no intention to limit the claim to only one such feature unless specifically stated to the contrary in the claim. When the language “at least a portion” and/or “a portion” is used the item can include a portion and/or the entire item unless specifically stated to the contrary.

What is claimed is:

1. A viscometer, comprising a housing;
a bob disposed in the housing such that a gap is provided between the bob and the housing, the bob comprising a magnet;
a linear support supporting the bob such that the bob is free to rotate with respect to the housing;
a flow inlet in the housing for providing fluid flow into the housing;
a flow outlet for providing fluid flow out of the housing; and
at least one coil disposed adjacent the housing for providing a magnetic field to induce oscillating rotational movement in the bob and to measure the movement of the bob;
wherein the viscometer is configured to measure a viscosity of a fluid by inducing movement in the bob and measuring a dampening effect of the fluid.

2. An ink jet printer comprising the viscometer of claim 1, wherein the fluid comprises ink.

3. The ink jet printer of claim 2 wherein the printer comprises a main ink tank and a subtank in fluid communication with the main ink tank, wherein the viscometer is disposed in the subtank.

4. The viscometer of claim 1 wherein the housing comprises an inner surface in the general shape of a hollow cylinder, the bob comprises an outer surface in the general shape of a cylinder, and the gap between the housing and the bob is ring-shaped.

5. The viscometer of claim 1 wherein the bob comprises tapered ends adjacent a connection with the linear support.

6. The viscometer of claim 1 wherein the linear support comprises a first linear support connecting a top of the bob to a top portion of the housing and a second linear support connecting a bottom of the bob to a bottom portion of the housing.

7. The viscometer of claim 1 wherein the bob is between 10 mm and 50 mm in length, between 10 mm and 20 mm in diameter, and the gap between the bob and the housing is at least 4 mm.

8. The viscometer of claim 1 wherein the at least one coil comprises a first coil for inducing movement in the bob and a second coil for measuring movement of the bob.

9. The viscometer of claim 1 wherein the viscometer is capable of measuring the viscosity of a fluid between 0.1 and 10 cP.

10. The viscometer of claim 1 wherein the viscometer is capable of measuring the viscosity of a fluid within 30 seconds.

11. The viscometer of claim 1 further comprising a fluid disposed in the viscometer, wherein the fluid comprises a dye and an organic solvent selected from methyl ethyl ketone, acetone, ethanol, and mixtures thereof.

12. The viscometer of claim 1 further comprising a controller in electrical communication with the at least one coil.

13. A method of measuring the viscosity of a fluid comprising:
providing a viscometer comprising:
a housing;
a bob disposed in housing such that a gap is provided between the bob and the housing, the bob comprising a magnet; and
a linear support supporting the bob and acting as a spring such that the bob is free to rotate with respect the housing;
disposing a fluid in the gap between the housing and the bob;
providing a magnetic field to induce oscillating rotational movement of the bob with respect to the housing;
measuring the oscillating rotational movement of the bob; and
determining a viscosity of the fluid from the oscillating rotational movement of the bob with time.

14. The method of claim 13 further comprising determining the viscosity of the fluid by measuring changes in the amplitude of the oscillating rotational movement of the bob with time.

15. The method of claim 13 further comprising determining the viscosity of the fluid by measuring changes in a width of a resonance peak in a frequency spectrum.

16. The method of claim 13 further comprising inputting the fluid density to calculate the viscosity.

17. The method of claim 13 wherein oscillating rotational movement of the bob is induced during flow of fluid though the gap.

18. The method of claim 13 further comprising measuring a temperature of the fluid.

19. The method of claim 13 further comprising calculating a damping constant of the fluid in the viscometer.

20. The method of claim 13 wherein the method is capable of determining a viscosity of the fluid to within 0.01 cP at a temperature between 20° C. and 40° C.

21. The method of claim 13 wherein the method is capable of determining a viscosity of fluids with densities in a range of 0.7 to 0.9 g/cm³.

22. The method of claim 13 further comprising an ink jet printer, wherein the fluid comprises a dye and an organic solvent selected from methyl ethyl ketone, acetone, ethanol, and mixtures thereof.
